(19) United States
(12) Patent Application Publication
(10) Pub. No.: US 2022/0009070 A1
(43) Pub. Date: Jan. 13, 2022

(54) Adjustable Leverage Arm Hammer Apparatus

(71) Applicant: Antonio Silvestre, Houston, TX (US)

(72) Inventor: Antonio Silvestre, Houston, TX (US)

(21) Appl. No.: 16/923,680

(22) Filed: Jul. 8, 2020

(51) Int. Cl. B25D 1/04

(52) U.S. Cl. CPC B25D 1/045; B25D 2250/005

(57) ABSTRACT

An adjustable leverage arm hammer apparatus for creating mechanical advantage for the claw when removing nails includes a handle. A handle top side has a post aperture extending towards a handle bottom side and a handle left side has an adjustment channel extending through to the post aperture. The handle top side is coupled within a handle aperture of a hammer head. A leverage arm is slidably coupled within the post aperture to move between a retracted position flush with a head top side of the hammer head and an extended position protruding above the head top side. A leveler has an adjustment track coupled within the adjustment channel and a slider coupled to the leverage arm and extending through the adjustment channel. The slider is in operational communication with the adjustment track to secure the leverage arm in position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hammer devices and more particularly pertains to a new hammer device for creating mechanical advantage for the claw when removing nails.

### (2) Description of Related Art Including Information Disclosed Under 37 CFR 1.97 and 1.98

The prior art relates to hammer devices. Existing devices offer a variety of adjustable arms and fulcrums, yet none that recess fully to be flush with the hammer head. Some existing devices also only move between a retracted position and an extended position without intermediary positions.

### BRIEF SUMMARY OF THE INVENTION

An embodiment of the disclosure meets the needs presented above by generally comprising a handle having a handle top side, a handle bottom side, a handle left side, a handle right side, a handle front side, and a handle back side. The handle top side has a post aperture extending towards the handle bottom side and the handle left side has an adjustment channel extending through to the post aperture. A hammer head is coupled to the handle. The hammer head has a handle aperture extending from a head top side through a head bottom side. The handle top side is coupled within the handle aperture. The hammer head has a neck portion, a face portion coupled to the neck portion, and a claw portion. A leverage arm is slidably coupled within the post aperture to move between a retracted position flush with the head top side of the hammer head and an extended position protruding above the head top side. A leveler has an adjustment track coupled within the adjustment channel and a slider coupled to the leverage arm and extending through the adjustment channel. The slider is in operational communication with the adjustment track to secure the leverage arm in the retracted position, the extended position, and a plurality of intermediary positions.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an adjustable leverage arm hammer apparatus according to an embodiment of the disclosure.

FIG. 2 is a side elevation view of an embodiment of the disclosure.

FIG. 3 is a front elevation view of an embodiment of the disclosure.

FIG. 4 is a rear elevation view of an embodiment of the disclosure.

FIG. 5 is an in-use view of an embodiment of the disclosure.

FIG. 6 is a top plan view of an embodiment of the disclosure.

### DETAILED DESCRIPTION OF THE INVENTION

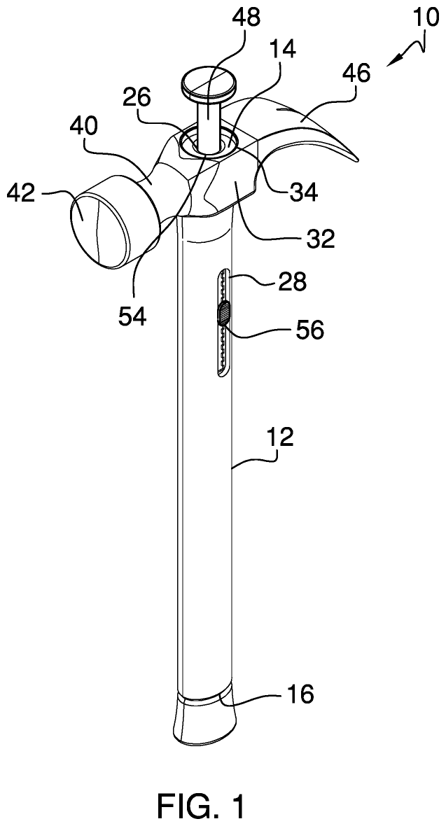

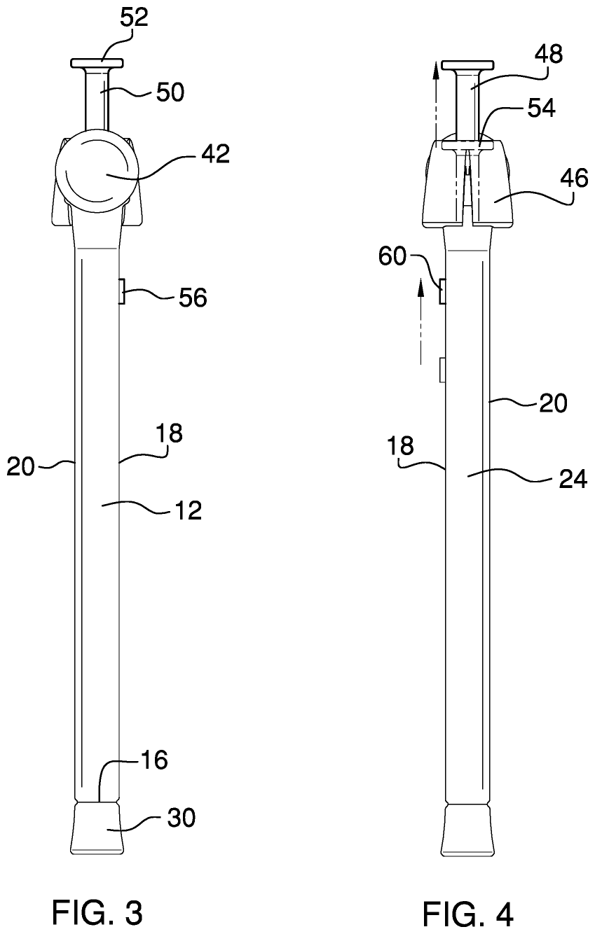

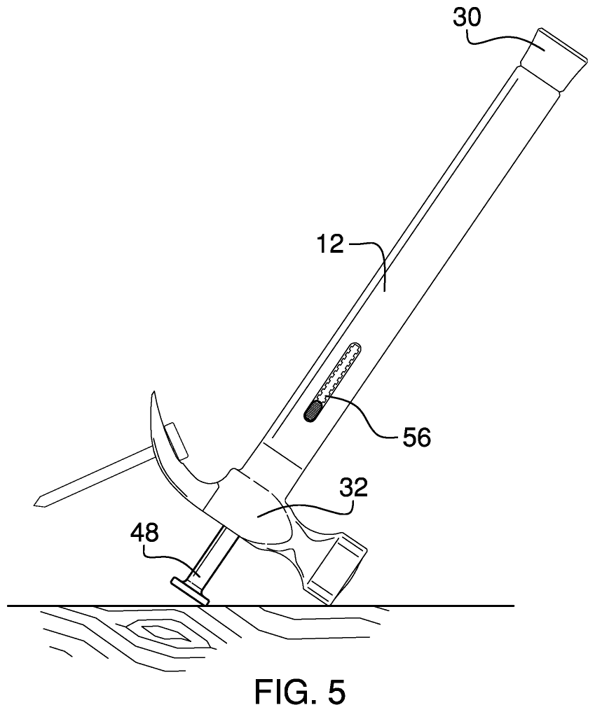

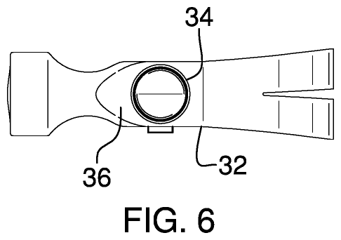

With reference now to the drawings, and in particular to FIGS. 1 through 6 thereof, a new hammer device embodying the principles and concepts of an embodiment of the disclosure and generally designated by the reference numeral 10 will be described.

As best illustrated in FIGS. 1 through 6, the adjustable leverage arm hammer apparatus 10 generally comprises a handle 12 having a handle top side 14, a handle bottom side 16, a handle left side 18, a handle right side 20, a handle front side 22, and a handle back side 24. The handle top side 14 has a post aperture 26 extending towards the handle bottom side 16. The post aperture 26 may extend less than halfway towards the handle bottom side 16. The handle left side 18 has an adjustment channel 28 extending through to the post aperture 26. The adjustment channel 28 may be obround.

A rubberized foot 30 may be coupled to the handle bottom side 16. The rubberized foot 30 prevents damage to the handle 12 or to other objects and serves as a grip to prevent the user's hand from slipping off the handle bottom side 16. The handle 12 may also have a rubberized grip portion extending from the handle bottom side 16 and surrounding the handle left side 18, the handle right side 20, the handle front side 22, and the handle back side 24.

A hammer head 32 is coupled to the handle 12. The hammer head 32 has a handle aperture 34 extending from a head top side 36 through a head bottom side 38. The handle top side 14 is coupled within the handle aperture 34 with the handle 12 protruding from the head bottom side 38. The hammer head 32 has a neck portion 40, a face portion 42 coupled to the neck portion 40, and a claw portion 46. The claw portion 46 may be curved or straight depending on the desired application for nail removal.

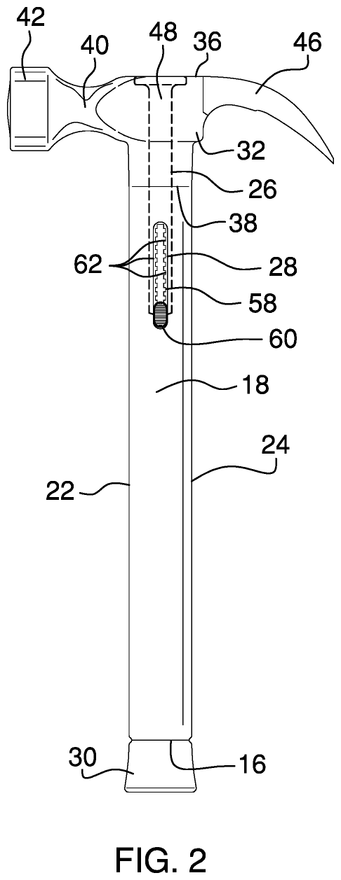

A leverage arm 48 is coupled to the handle 12. The leverage arm 48 has a post portion 50 and a top portion 52. The post portion 50 is slidably coupled within the post aperture 26 to move the top portion 52 between a retracted position flush with the head top side 36 of the hammer head (best seen in FIG. 2) and an extended position protruding above the head top side 36 (best seen in FIGS. 1 and 3-5). The top portion 52 may be circular and conforms to a cavity 54 defined by the handle top side 14 and the handle aperture 34.

A leveler 56 is coupled to the leverage arm 48. The leveler 56 may have an adjustment track 58 coupled within the adjustment channel 28 and a slider 60 coupled to the leverage arm 48 and extending through the adjustment channel 28. The slider 60 may be obround and textured for improved grip. The slider 60 is in operational communication with the adjustment track 58 to secure the leverage arm 48 in the retracted position, the extended position, and a plurality of intermediary positions. The adjustment track 58 may have a plurality of teeth 62 with the slider 60 ratchetingly sliding between adjacent teeth 62 of the plurality of teeth only when the slider 60 is depressed.

In use, the handle 12 may be secured to use the face portion 42 of the hammer head like a traditional hammer. When the claw portion 46 is used, the leveler 56 may be manipulated to move the leverage arm 48 to the extended position in order to adjust the fulcrum of the apparatus while removing nails.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable leverage arm hammer apparatus comprising:
a handle having a handle top side, a handle bottom side, a handle left side, a handle right side, a handle front side, and a handle back side, the handle top side having a post aperture extending towards the handle bottom side, the handle left side having an adjustment channel extending through to the post aperture;
a hammer head coupled to the handle, the hammer head having a handle aperture extending from a head top side through a head bottom side, the handle top side being coupled within the handle aperture, the hammer head having a neck portion, a face portion coupled to the neck portion, and a claw portion;
a leverage arm coupled to the handle, the leverage arm being slidably coupled within the post aperture to move between a retracted position flush with the head top side of the hammer head and an extended position protruding above the head top side; and
a leveler coupled to the leverage arm, the leveler having an adjustment track coupled within the adjustment channel and a slider coupled to the leverage arm and extending through the adjustment channel, the slider being in operational communication with the adjustment track to secure the leverage arm in the retracted position, the extended position, and a plurality of intermediary positions.

2. The adjustable leverage arm hammer apparatus of claim 1 further comprising the leverage arm having a post portion and a top portion, the post portion being slidably coupled within the post aperture.

3. The adjustable leverage arm hammer apparatus of claim 2 further comprising the top portion being circular and conforming to a cavity defined by the handle top side and the handle aperture.

4. The adjustable leverage arm hammer apparatus of claim 1 further comprising the post aperture extending less than halfway towards the handle bottom side.

5. The adjustable leverage arm hammer apparatus of claim 1 further comprising a rubberized foot coupled to the handle bottom side.

6. The adjustable leverage arm hammer apparatus of claim 1 further comprising the claw portion being curved.

7. The adjustable leverage arm hammer apparatus of claim 1 further comprising the claw portion being straight.

8. The adjustable leverage arm hammer apparatus of claim 1 further comprising the adjustment track having a plurality of teeth, the slider ratchetingly sliding between adjacent teeth.

9. The adjustable leverage arm hammer apparatus of claim 1 further comprising the leverage arm being slidable only when the slider is depressed.

10. The adjustable leverage arm hammer apparatus of claim 1 further comprising the slider being obround and textured for improved grip.

11. An adjustable leverage arm hammer apparatus comprising:
a handle having a handle top side, a handle bottom side, a handle left side, a handle right side, a handle front side, and a handle back side, the handle top side having a post aperture extending towards the handle bottom side, the post aperture extending less than halfway towards the handle bottom side, the handle left side having an adjustment channel extending through to the post aperture;
a rubberized foot coupled to the handle bottom side;
a hammer head coupled to the handle, the hammer head having a handle aperture extending from a head top side through a head bottom side, the handle top side being coupled within the handle aperture, the hammer head having a neck portion, a face portion coupled to the neck portion, and a claw portion;
a leverage arm coupled to the handle, the leverage arm having a post portion and a top portion, the post portion being slidably coupled within the post aperture to move the top portion between a retracted position flush with the head top side of the hammer head and an extended position protruding above the head top side, the top portion being circular and conforming to a cavity defined by the handle top side and the handle aperture; and
a leveler coupled to the leverage arm, the leveler having an adjustment track coupled within the adjustment channel and a slider coupled to the leverage arm and extending through the adjustment channel, the slider being obround and textured for improved grip, the slider being in operational communication with the adjustment track to secure the leverage arm in the retracted position, the extended position, and a plurality of intermediary positions, the adjustment track having a plurality of teeth, the slider ratchetingly sliding between adjacent teeth of the plurality of teeth only when the slider is depressed.
